(19) United States
(12) Patent Application Publication
(10) Pub. No.: US 2024/0144516 A1
(43) Pub. Date: May 2, 2024

(54) POSE ESTIMATION FOR IMAGE RECONSTRUCTION

(71) Applicant: QUALCOMM Incorporated, San Diego, CA (US)

(72) Inventors: Gabriele CESA, Diemen (NL); Kumar PRATIK, Amsterdam (NL); Arash BEHBOODI, Amsterdam (NL)

(21) Appl. No.: 18/485,298

(22) Filed: Oct. 11, 2023

Related U.S. Application Data
(60) Provisional application No. 63/415,934, filed on Oct. 13, 2022.

(51) Int. Cl. G06T 7/70; G06T 17/00; G06V 10/24; G06V 20/69

(52) U.S. Cl. CPC G06T 7/70; G06T 17/00; G06V 10/24; G06V 20/69; G06T 2207/10056; G06T 2207/20084

(57) ABSTRACT

A computer-implemented method for estimating a pose of an object includes receiving, at a pose estimation model, image data comprising a plurality of two-dimensional (2D) images of an object. Each 2D image of the plurality of 2D images has a different pose. The pose estimation model aligns a first 2D image of the plurality of 2D images with a second 2D image of the plurality of 2D images based on geometric properties related to the first 2D image and the second 2D image. The pose estimation model estimates a pose of the first 2D image and the second 2D image based on the plurality of 2D images and a loss associated with a common line between the first 2D image and the second 2D image.

### CROSS-REFERENCE TO RELATED APPLICATION

The present application claims the benefit of U.S. Provisional Patent Application No. 63/415,934, filed on Oct. 13, 2022, and titled “POSE ESTIMATION FOR IMAGE RECONSTRUCTION,” the disclosure of which is expressly incorporated by reference in its entirety.

### FIELD OF THE DISCLOSURE

Aspects of the present disclosure generally relate to machine learning, and more specifically to pose estimation for image reconstruction.

### BACKGROUND

Reconstructing a three-dimensional (3D) image from two-dimensional (2D) image data is an inherently complex problem. This complexity is increased when the 2D data is noisy and the projection directions (e.g., the pose of both the image and the imager) are unknown. Such reconstructions may be used in various imaging technologies, such as cryogenic-electron microscopy (cryo-EM) and other imaging techniques.

Cryo-EM is an example of an imaging technique used to reconstruct biomolecules at high resolutions. Cryo-EM produces 2D projections of the 3D density from random directions. As discussed, the 2D projections may be noisy images. 3D reconstruction may be performed by estimating the orientations (e.g., poses) of each observed image, and then combining the images to find the most likely 3D structure.

Some conventional 3D reconstruction systems estimate poses of one or more 2D images while simultaneously estimating a 3D model. Therefore, conventional 3D reconstruction systems may suffer from slow convergence. It may be desirable to improve estimating a pose of an image from a group of 2D images.

### SUMMARY

In some aspects of the present disclosure, a computer-implemented method that includes receiving, at a pose estimation model, image data comprising multiple two-dimensional (2D) images of an object. Each 2D image of the multiple 2D images has a different pose. The method also includes aligning a first 2D image of the plurality of 2D images with a second 2D image of the plurality of 2D images based on geometric properties related to the first 2D image and the second 2D image. The method further includes estimating, via the pose estimation model, a pose of the first 2D image and the second 2D image based on the plurality of 2D images and a loss associated with a common line between the first 2D image and the second 2D image.

Various aspects of the present disclosure are directed to an apparatus including means for receiving, at a pose estimation model, image data comprising multiple two-dimensional (2D) images of an object. Each 2D image of the multiple 2D images has a different pose. The apparatus also includes means for aligning a first 2D image of the plurality of 2D images with a second 2D image of the plurality of 2D images based on geometric properties related to the first 2D image and the second 2D image. The apparatus further includes means for estimating, via the pose estimation model, a pose of the first 2D image and the second 2D image based on the plurality of 2D images and a loss associated with a common line between the first 2D image and the second 2D image.

In some aspects of the present disclosure, a non-transitory computer-readable medium with non-transitory program code recorded thereon is disclosed. The program code is executed by a processor and includes program code to receive, at a pose estimation model, image data comprising multiple two-dimensional (2D) images of an object. Each 2D image of the multiple 2D images has a different pose. The program code also includes program code to align a first 2D image of the plurality of 2D images with a second 2D image of the plurality of 2D images based on geometric properties related to the first 2D image and the second 2D image. The program code further includes program code to estimate, via the pose estimation model, a pose of the first 2D image and the second 2D image based on the plurality of 2D images and a loss associated with a common line between the first 2D image and the second 2D image.

Various aspects of the present disclosure are directed to an apparatus having a memory and one or more processors coupled to the memory. The processor(s) is configured to receive, at a pose estimation model, image data comprising multiple two-dimensional (2D) images of an object. Each 2D image of the multiple 2D images has a different pose. The processor(s) is also configured to align aligning a first 2D image of the plurality of 2D images with a second 2D image of the plurality of 2D images based on geometric properties related to the first 2D image and the second 2D image. The processor(s) is also configured to estimate, via the pose estimation model, a pose of the first 2D image and the second 2D image based on the plurality of 2D images and a loss associated with a common line between the first 2D image and the second 2D image.

Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 illustrates an example implementation of a neural network using a system-on-a-chip (SOC), including a general-purpose processor in accordance with certain aspects of the present disclosure.

FIGS. 2A, 2B, and 2C are diagrams illustrating a neural network in accordance with various aspects of the present disclosure.

FIG. 3 is a block diagram illustrating an exemplary deep convolutional network (DCN) in accordance with various aspects of the present disclosure.

FIG. 4 is a block diagram illustrating an exemplary software architecture that may modularize artificial intelligence (AI) functions, in accordance with various aspects of the present disclosure.

FIG. 5 is a diagram illustrating an example image formation, in accordance with various aspects of the present disclosure.

FIG. 6 is a block diagram illustrating an example processing pipeline for estimating a three-dimensional (3D) volume based on two-dimensional (2D) images, in accordance with various aspects of the present disclosure.

FIG. 7 is a flow diagram illustrating an example of a computer-implemented method for deep pose estimation, in accordance with various aspects of the present disclosure.

### DETAILED DESCRIPTION

The detailed description set forth below in connection with the appended drawings, is intended as a description of various configurations and is not intended to represent the only configurations in which the concepts described may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

Based on the teachings, one skilled in the art should appreciate that the scope of the disclosure is intended to cover any aspect of the disclosure, whether implemented independently of or combined with any other aspect of the disclosure. For example, an apparatus may be implemented or a method may be practiced using any number of the aspects set forth. In addition, the scope of the disclosure is intended to cover such an apparatus or method practiced using other structure, functionality, or structure and functionality in addition to or other than the various aspects of the disclosure set forth. It should be understood that any aspect of the disclosure disclosed may be embodied by one or more elements of a claim.

The word “exemplary” is used to mean “serving as an example, instance, or illustration.” Any aspect described as “exemplary” is not necessarily to be construed as preferred or advantageous over other aspects.

Although particular aspects are described, many variations and permutations of these aspects fall within the scope of the disclosure. Although some benefits and advantages of the preferred aspects are mentioned, the scope of the disclosure is not intended to be limited to particular benefits, uses or objectives. Rather, aspects of the disclosure are intended to be broadly applicable to different technologies, system configurations, networks, and protocols, some of which are illustrated by way of example in the figures, and in the following description of the preferred aspects. The detailed description and drawings are merely illustrative of the disclosure rather than limiting, the scope of the disclosure being defined by the appended claims and equivalents thereof.

Cryogenic electron microscopy (Cryo-EM) is a popular technique in structural biology for capturing and studying the structure of macromolecules. In single particle cryo-EM, a field of the intended specimen may be prepared, and the solution may be frozen to cryogenic temperature. A single image may be taken using tomographic projections by an electron microscope, yielding multiple two-dimensional (2D) images of the intended specimen (e.g., macromolecules or proteins). The 2D image projections obtained may be noisy images. One task is to find the three-dimensional 3D structure of the molecule from the noisy 2D images. However, 3D reconstruction, considered as an inverse problem, includes many challenges such as: low signal-to-noise ratio (SNR), model mismatch with contrast transfer function (CTF) of the microscope, heterogeneity of the imaged molecules, and molecule in-place translations. Another challenge for 3D reconstruction involves unknown molecule poses in the 2D images. That is, each of the 2D images represents a different random view of the same molecule but the orientation (referred to as a pose) of the images may not be known. When molecule poses are known, a 3D reconstruction may be estimated by inverting the projection via tomographic reconstruction. However, the frozen specimens may be differently oriented in the space prior to the tomographic projections.

Some conventional approaches employ a pure synchronization technique that ignores the image formation model and suffers in performance in the lowest signal-to-noise ratio (SNR) regimes. On the other hand, in conventional approaches that employ expectation-maximization (EM)-based techniques, pose estimation and 3D reconstruction may be performed in an iterative fashion. Although such conventional approaches may directly incorporate the data's generative process when estimating the poses, the conventional approaches using EM-based techniques may suffer from convergence issues and additional overhead when performing 3D reconstruction at each iteration.

To address these and other challenges, aspects of the present disclosure are directed to a deep learning-based method able to directly infer poses of images, while accounting for the model generating of the images. A multi-layer equivariant graph neural network may concurrently process a dataset (or a subset) of projection images and predict an initial estimation of the underlying poses. The equivariant design may enable encoding prior knowledge regarding the geometry of the problem into the architecture: namely, that the predicted poses may be consistent across rotated and mirrored versions of the same image. In some aspects, a refinement process may increase the accuracy of the estimates.

Because ground truth orientations may not be available in real datasets, a self-supervised learning approach may be implemented using a common lines-based loss to train the network. A principle of common lines is that any two 2D images should contain a pair of central lines on which their Fourier transforms agree (e.g., are common). This common line may capture two of the three angles in the relative pose of underlying molecules, and all common lines can be used for final pose estimation and reconstruction. However, the estimation of common lines is itself expensive and sensitive to noise. Accordingly, the information of common lines may be used directly rather than relying only on relative poses. Using the common lines-based loss may enforce the consistency of image pairs along the common line defined by their estimated poses. Thus, aspects of the present disclosure may explicitly account for the generative process of the images during the training phase, thereby circumventing the limitations of conventional approaches that employ pure synchronization techniques. Furthermore, aspects of the present disclosure may amortize the cost of pose estimation over images and may be scaled up using batches of random subsets of images at each iteration.

Various aspects of the present disclosure are directed to estimating an orientation of each image, such as a 2D image, from a collection of images. An orientation of a 3D image may be determined based on estimating the orientation of each 2D image. In some examples, a pose of a cryo-EM image may be estimated from a group of raw images (e.g., 2D images), without the use of a 3D reference model. Aspects of the present disclosure may improve an accuracy of a 3D pose estimation while improving convergence speeds.

Various aspects of the present disclosure may be applicable to any sort of image reconstruction task in which 2D image data may be used to generate 3D models of objects. The 2D image data may be generated by a tomographic projection. Throughout this disclosure, cryogenic-electron microscopy (cryo-EM) is used as one example use case. As noted, aspects of the present disclosure may be applicable in other imaging and reconstruction contexts.

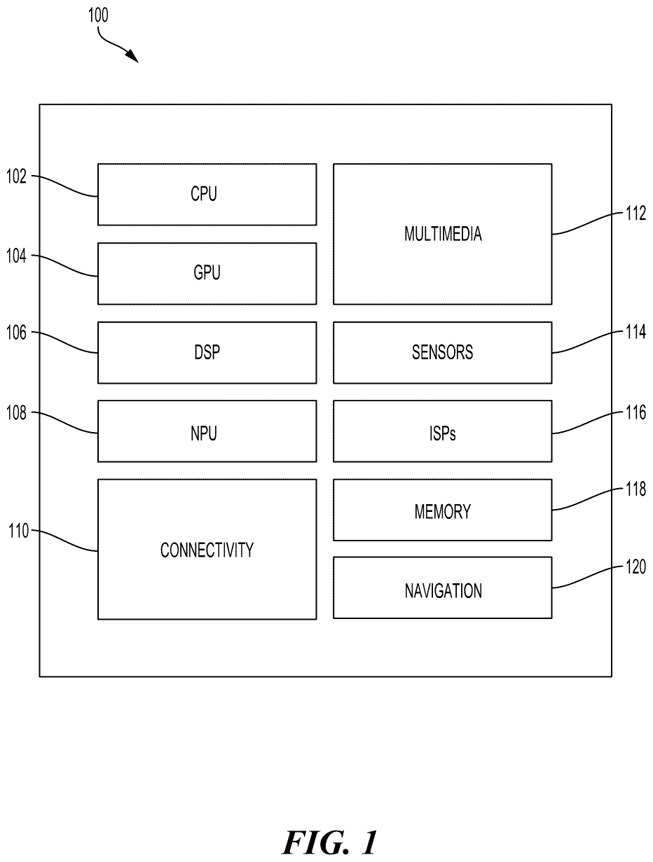

FIG. 1 illustrates an example implementation of a system-on-a-chip (SOC) 100, which may include a central processing unit (CPU) 102 or a multi-core CPU configured for estimating a pose of an image. Variables (e.g., neural signals and synaptic weights), system parameters associated with a computational device (e.g., neural network with weights), delays, frequency bin information, and task information may be stored in a memory block associated with a neural processing unit (NPU) 108, in a memory block associated with a CPU 102, in a memory block associated with a graphics processing unit (GPU) 104, in a memory block associated with a digital signal processor (DSP) 106, in a memory block 118, or may be distributed across multiple blocks. Instructions executed at the CPU 102 may be loaded from a program memory associated with the CPU 102 or may be loaded from a memory block 118.

The SOC 100 may also include additional processing blocks tailored to specific functions, such as a GPU 104, a DSP 106, a connectivity block 110, which may include fifth generation (5G) connectivity, fourth generation long term evolution (4G LTE) connectivity, Wi-Fi connectivity, USB connectivity, Bluetooth connectivity, and the like, and a multimedia processor 112 that may, for example, detect and recognize gestures. In one implementation, the NPU 108 is implemented in the CPU 102, DSP 106, and/or GPU 104. The SOC 100 may also include a sensor processor 114, image signal processors (ISPs) 116, and/or navigation module 120, which may include a global positioning system.

The SOC 100 may be based on an ARM instruction set. In some aspects of the present disclosure, the instructions loaded into the general-purpose processor 102 may include code to receive, at a pose estimation model, image data comprising a plurality of two-dimensional (2D) images of an object. Each 2D image of the plurality of 2D images has a different pose. The instructions loaded into the general-purpose processor 102 may also include code to align aligning a first 2D image of the plurality of 2D images with a second 2D image of the plurality of 2D images based on geometric properties related to the first 2D image and the second 2D image. The instructions loaded into the general-purpose processor 102 may also include code to estimate, via the pose estimation model, a pose of the first 2D image and the second 2D image based on the plurality of 2D images and a loss associated with a common line between the first 2D image and the second 2D image.

Deep learning architectures may perform an object recognition task by learning to represent inputs at successively higher levels of abstraction in each layer, thereby building up a useful feature representation of the input data. In this way, deep learning addresses a major bottleneck of traditional machine learning. Prior to the advent of deep learning, a machine learning approach to an object recognition problem may have relied heavily on human engineered features, perhaps in combination with a shallow classifier. A shallow classifier may be a two-class linear classifier, for example, in which a weighted sum of the feature vector components may be compared with a threshold to predict to which class the input belongs. Human engineered features may be templates or kernels tailored to a specific problem domain by engineers with domain expertise. Deep learning architectures, in contrast, may learn to represent features that are similar to what a human engineer might design, but through training. Furthermore, a deep network may learn to represent and recognize new types of features that a human might not have considered.

A deep learning architecture may learn a hierarchy of features. If presented with visual data, for example, the first layer may learn to recognize relatively simple features, such as edges, in the input stream. In another example, if presented with auditory data, the first layer may learn to recognize spectral power in specific frequencies. The second layer, taking the output of the first layer as input, may learn to recognize combinations of features, such as simple shapes for visual data or combinations of sounds for auditory data. For instance, higher layers may learn to represent complex shapes in visual data or words in auditory data. Still higher layers may learn to recognize common visual objects or spoken phrases.

Deep learning architectures may perform especially well when applied to problems that have a natural hierarchical structure. For example, the classification of motorized vehicles may benefit from first learning to recognize wheels, windshields, and other features. These features may be combined at higher layers in different ways to recognize cars, trucks, and airplanes.

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input.

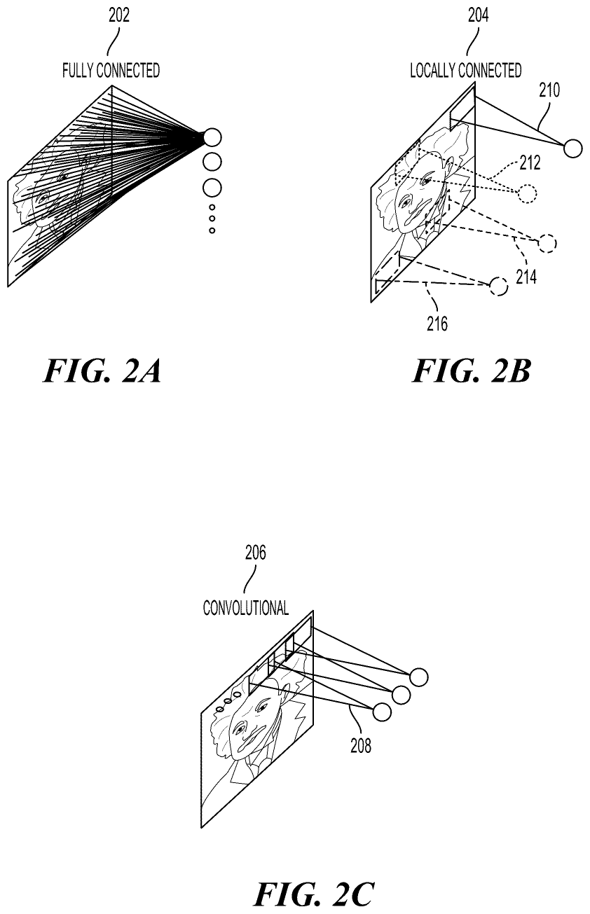

The connections between layers of a neural network may be fully connected or locally connected. FIG. 2A illustrates an example of a fully connected neural network 202. In a fully connected neural network 202, a neuron in a first layer may communicate its output to every neuron in a second layer, so that each neuron in the second layer will receive input from every neuron in the first layer. FIG. 2B illustrates an example of a locally connected neural network 204. In a locally connected neural network 204, a neuron in a first layer may be connected to a limited number of neurons in the second layer. More generally, a locally connected layer of the locally connected neural network 204 may be configured so that each neuron in a layer will have the same or a similar connectivity pattern, but with connections strengths that may have different values (e.g., 210, 212, 214, and 216). The locally connected connectivity pattern may give rise to spatially distinct receptive fields in a higher layer because the higher layer neurons in a given region may receive inputs that are tuned through training to the properties of a restricted portion of the total input to the network.

One example of a locally connected neural network is a convolutional neural network. FIG. 2C illustrates an example of a convolutional neural network 206. The convolutional neural network 206 may be configured such that the connection strengths associated with the inputs for each neuron in the second layer are shared (e.g., 208). Convolutional neural networks may be well suited to problems in which the spatial location of inputs is meaningful.

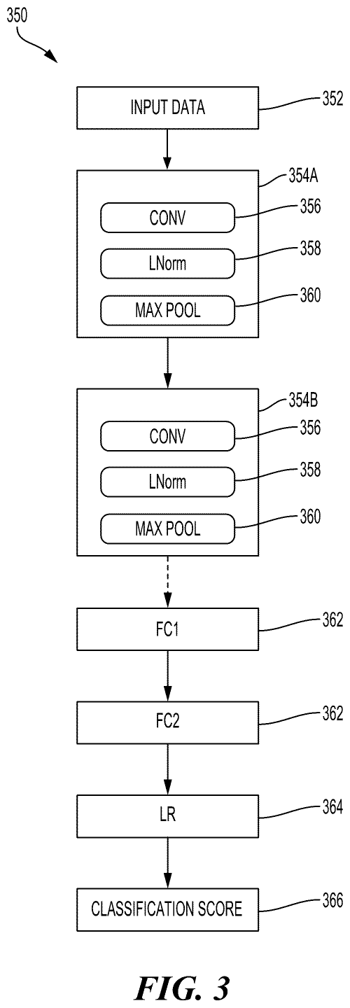

FIG. 3 is a block diagram illustrating a DCN 350. The DCN 350 may include multiple different types of layers based on connectivity and weight sharing. As shown in FIG. 3, the DCN 350 includes the convolution blocks 354A, 354B. Each of the convolution blocks 354A, 354B may be configured with a convolution layer (CONV) 356, a normalization layer (LNorm) 358, and a max pooling layer (MAX POOL) 360.

Although only two of the convolution blocks 354A, 354B are shown, the present disclosure is not so limiting, and instead, any number of the convolution blocks 354A, 354B may be included in the DCN 350 according to design preference.

The convolution layers 356 may include one or more convolutional filters, which may be applied to the input data to generate a feature map. The normalization layer 358 may normalize the output of the convolution filters. For example, the normalization layer 358 may provide whitening or lateral inhibition. The max pooling layer 360 may provide down sampling aggregation over space for local invariance and dimensionality reduction.

The parallel filter banks, for example, of a deep convolutional network may be loaded on a CPU 102 or GPU 104 of an SOC 100 (e.g., FIG. 1) to achieve high performance and low power consumption. In alternative embodiments, the parallel filter banks may be loaded on the DSP 106 or an ISP 116 of an SOC 100. In addition, the DCN 350 may access other processing blocks that may be present on the SOC 100, such as sensor processor 114 and navigation module 120, dedicated, respectively, to sensors and navigation.

The DCN 350 may also include one or more fully connected layers 362 (FC1 and FC2). The DCN 350 may further include a logistic regression (LR) layer 364. Between each layer 356, 358, 360, 362, 364 of the DCN 350 are weights (not shown) that are to be updated. The output of each of the layers (e.g., 356, 358, 360, 362, 364) may serve as an input of a succeeding one of the layers (e.g., 356, 358, 360, 362, 364) in the DCN 350 to learn hierarchical feature representations from input data 352 (e.g., images, audio, video, sensor data and/or other input data) supplied at the first of the convolution blocks 354A. The output of the DCN 350 is a classification score 366 for the input data 352. The classification score 366 may be a set of probabilities, where each probability is the probability of the input data including a feature from a set of features.

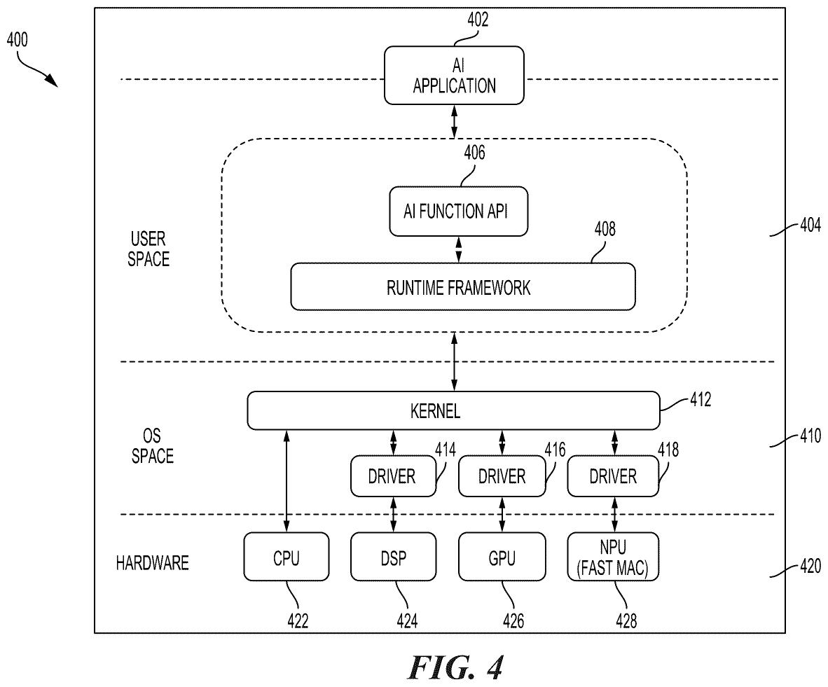

FIG. 4 is a block diagram illustrating an exemplary software architecture 400 that may modularize artificial intelligence (AI) functions. Using the architecture 400, applications may be designed that may cause various processing blocks of an SOC 420 (for example a CPU 422, a DSP 424, a GPU 426 and/or an NPU 428) (which may be similar to SOC 100 of FIG. 1) to support estimating a pose of 2D images for an AI application 402, according to aspects of the present disclosure. The architecture 400 may, for example, be included in a computational device, such as a smartphone.

The AI application 402 may be configured to call functions defined in a user space 404 that may, for example, provide for the detection and recognition of a scene indicative of the location at which the computational device including the architecture 400 currently operates. The AI application 402 may, for example, configure a microphone and a camera differently depending on whether the recognized scene is an office, a lecture hall, a restaurant, or an outdoor setting such as a lake. The AI application 402 may make a request to compiled program code associated with a library defined in an AI function application programming interface (API) 406. This request may ultimately rely on the output of a deep neural network configured to provide an inference response based on video and positioning data, for example.

The run-time engine 408, which may be compiled code of a runtime framework, may be further accessible to the AI application 402. The AI application 402 may cause the run-time engine 408, for example, to request an inference at a particular time interval or triggered by an event detected by the user interface of the AI application 402. When caused to provide an inference response, the run-time engine 408 may in turn send a signal to an operating system in an operating system (OS) space 410, such as a Kernel 412, running on the SOC 420. In some examples, the Kernel 412 may be a LINUX Kernel. The operating system, in turn, may cause a continuous relaxation of quantization to be performed on the CPU 422, the DSP 424, the GPU 426, the NPU 428, or some combination thereof. The CPU 422 may be accessed directly by the operating system, and other processing blocks may be accessed through a driver, such as a driver 414, 416, or 418 for, respectively, the DSP 424, the GPU 426, or the NPU 428. In the exemplary example, the deep neural network may be configured to run on a combination of processing blocks, such as the CPU 422, the DSP 424, and the GPU 426, or may be run on the NPU 428.

As described, cryogenic-electron microscopy (cryo-EM) involves generating a reconstruction of a 3D structure of the molecule from the noisy 2D-images. Cryo-EM is challenging, in part because there may be no ground truth samples available. Thus, training an artificial neural network model is challenging.

Accordingly, aspects of the present disclosure are directed to a deep learning-based method able to directly infer poses of images, while accounting for the generation model of the images. A multi-layer equivariant graph neural network may concurrently process a dataset (or a subset) of projection images and predict an initial estimation of the underlying poses. In some aspects, the 3D image poses may be determined based on a similarity and alignment between image pairs among the 2D images. Additionally, in various aspect, the similarity may be enforced based on a loss associated with a common line between the 2D image pairs.

In a simplified, abstract setting, a cryo-EM image formation model may be summarized as follows. Given a 3D density function Ψ of a molecule where Ψ: [symbol] ³→z,21

and that SO(3) represents the group of 3D rotations, SO(2) represents the group of 2D rotations, and O(2) represents the group of 2D rotations and reflections. The 3D rotation Rᵢ of a molecule (or an object), where Rᵢ 531 SO(3) may be written as Rᵢ=(xᵢ, yᵢ, zᵢ) ∈ [symbol] ^{3×3}, with xᵢ, yᵢ, zᵢ∈E [symbol] ³ to indicate the three orthonormal columns of the matrix Rᵢ.

Then, an image oᵢ: [symbol] ²→ [symbol] is generated by the tomographic projection Π along the z-axis of the molecule after being rotated by Rᵢ⁻¹, e.g., oᵢ=Π(Rᵢ⁻¹·Ψ):

oᵢ(x, y)=[Π(Rᵢ⁻¹·Ψ)](x, y) (1)

=∫_{z}Ψ(Rᵢ(x,y,z)^{T})dz (2)

=∫_{z}Ψ(xxᵢ,yyᵢ,zzᵢ)dz, (3)

where (x, y, z)^{T}∈ [symbol] ³ is interpreted as a 3D vector. Then, the vector zᵢ ∈ [symbol] ³ is the direction along which the projection is performed.

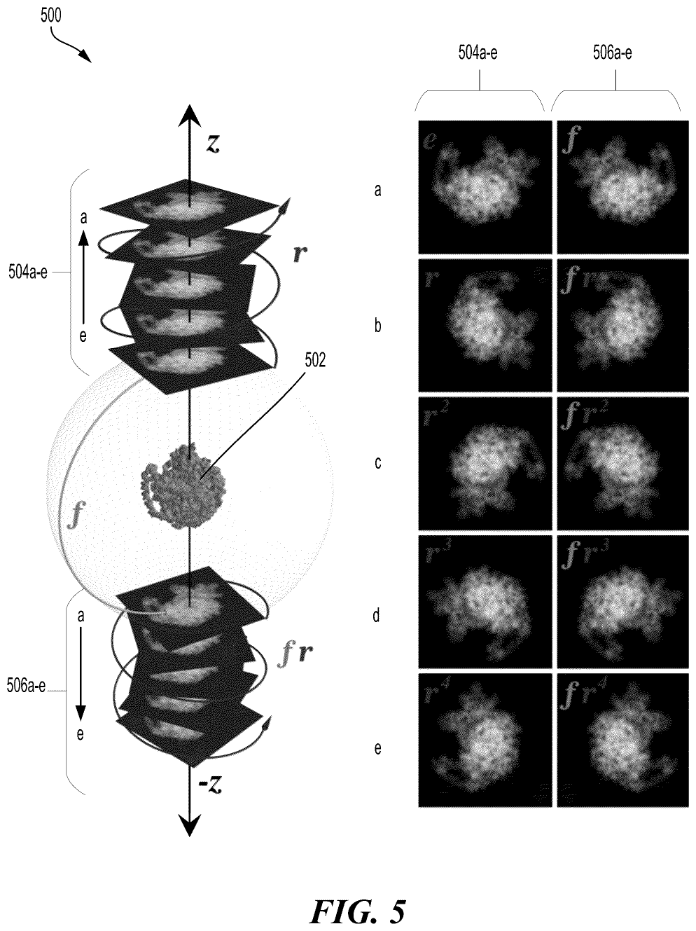

FIG. 5 is a diagram illustrating an example image formation 500, in accordance with various aspects of the present disclosure. As shown in FIG. 5, a set of images (504a-e, 506a-e) of a molecule 502 may be obtained by a tomographic projection along the same axis z. Five images are shown in each of the image sets (504a-e and 506a-e) for ease of illustration, however, the present disclosure is not so limiting and any number of images may be included in the image sets.

In cryo-EM, the image sets may have reflection equivariance and O(2) equivariance. That is, because the two images (e.g., 504a and 506a) have an opposite viewing direction along the z-axis (e.g., z and −z, respectively), the images (e.g., 504a and 506a) may differ by a planar reflection ƒᵣ∈O(2). Additionally, the images (e.g., 504a and 506a) may be related by a planar rotation r ∈SO(2). Accordingly, the geometric properties among pairs of images, including (but not limited to) the planar reflection ƒr or the planar rotation r may be employed to align pairs of images (e.g., 504a and 506a).

In various aspects of the present disclosure, a deep learning model Φ_{θ} may be trained such that given a set of images {oᵢ}i=1^{N} in input, the deep learning model Φ_{θ} may generate an estimate of the corresponding poses {Rᵢ}i^{N} of the set of images and/or may model a posterior distribution q_{θ}({R_{i}i}|{o_{i}i}) over the set of images.

Because a cryo-EM dataset generally does not include ground truth data regarding the poses or the 3D density, a self-supervised geometric loss may be employed for training the deep learning model Φ_{θ}. For each pair of images oᵢ and oⱼ, a neural network Φ_{θ} may sample or estimate the poses Rᵢ and Rⱼ. In some aspects, the deep learning model Φ_{θ} may estimate the pose of each image independently or jointly.

The neural network model Φ_{θ} may be trained to minimize the difference between the images oᵢ and oⱼ in the Fourier domain along a corresponding common line, which may be estimated directly from Rᵢ and Rⱼ. A common line approach to cryo-EM provides that the Fourier transforms of cryo-EM image pairs align along a line passing through the origin of the image pairs (e.g., 504a and 506a). As such, common lines may establish constraints on an absolute pose of each pair of images, which may be solved to estimate the final poses (e.g., orientations) of the images. However, the estimation of common lines is a computationally expensive and time consuming process that involves comparing each pair of images. Additionally, the common lines approach is highly sensitive to noise, which is challenging because the 2D images in cryo-EM are noisy images.

However, considering the common lines in images oᵢ and oⱼ, the tomographic projection Π may be a linear operator and correspond to a one-dimensional (1D) frequency-0 Fourier Transform [symbol] ₁ of the 3D density along the z-axis. That is, the tomographic projection Π may correspond to the mean of the 3D density along the z-axis. As such, the images and the 3D density may be parameterized in the Fourier domain.

The 3D density Ψ and any 2D image oᵢ may be approximately band-limited and locally supported. The 3D density Ψ and any 2D image oᵢ, as well as corresponding Fourier transform may also be square-integrable, which may ensure the invertibility of the Fourier transform and the unitary action of the rotations on the images. The d-dimensional Fourier transform operator may be denoted [symbol] _{d}[•], the 3D Fourier transform of the 3D density Ψ may be denoted [symbol] ₃[Ψ]∈L² [symbol] ³) and with respect to the 2D images oᵢ, the 2D Fourier transform of the images may be denoted as [symbol] ₂[oᵢ]∈L² [symbol] ²). The Fourier transform [symbol] _{d}[•]: [symbol] ^{d}→

[symbol]

may be a complex-valued signal.

The 2D and 3D Fourier transforms may be defined as follows:

ôᵢ(kₓ, k_{y})= [symbol] ₂[oᵢ](kₓ, k_{y})= [symbol] oᵢ(x,y)e^{-i2π(xjx+yky)}dxdy (4)

\hat{Ψ}(kₓ,k_{y},k_{z})= [symbol] ₃[Ψ](kₓ,k_{y},k_{z})= [symbol] Ψ(x,y,z)e^{-i2π(xkx+yky+zkz)}dz (5)

where kₓ, k_{y}, and k_{z} represent the frequency in x, y, and z directions, respectively.

Applying the Fourier transform on 2D image o f in Equation 1 and defining k=(kₓ, k_{y}, 0)^{T} may produce:

[symbol]

₂[oᵢ](kₓ,k_{y})= [symbol] ₃[Rᵢ⁻¹·Ψ](kₓ,k_{y},0) (6)

= [symbol] ₃[Rᵢ⁻¹·Ψ](k)= [symbol] ₃[Ψ](Rᵢ·k). (7)

That is, the Fourier transform of the image o f may correspond to a 2D slice of the Fourier transform of the 3D density Ψ along the plane obtained by rotating the x-y plane (e.g., orthogonal to the z-axis) with Rᵢ. In particular, if Rᵢ=(xᵢ, yᵢ, zᵢ) ∈SO(3), where SO(3) is the group of all rotations in 3D, the plane is spanned precisely by xᵢ and yᵢ and is orthogonal to zᵢ. Accordingly, the Fourier transforms of different images may correspond to different 2D slices of the Fourier transform of the 3D density.

As thus, the tomographic projection operator L may be defined directly in the Fourier domain Π: L²( [symbol] ³)→L² [symbol] ³) as:

[Π [symbol] ₃[Ψ]](x, y): = [symbol] ₃[Ψ](x,y,0). (8)

Thus, the common lines provides that the Fourier transforms ( [symbol] ₂|oᵢ|, [symbol] ₂|oⱼ|) of any two (non-coplanar) images (oᵢ, oⱼ) may agree exactly along a line passing through the origin (e.g., along the intersection of the corresponding 2D slices). Geometrically, because the common line belongs to both planes, the common line is orthogonal to both zᵢ and zⱼ. Therefore, the common line is spanned by the cross-product of zᵢ and zⱼ, that is by the vector

$${l}_{i j} = \frac{{z}_{i} \times {z}_{j}}{‖ {z}_{i} \times {z}_{j} ‖} ∈ {ℝ}^{3} .$$

A common line loss (e.g., self-supervised loss) may be derived from variational inference principles to encode information of the cryo-EM generative process.

The unknown poses of the 2D images may be considered as latent variables, a posterior (e.g., an encoder) q_{θ}({R_{i}i}|{x_{i}i}), parameterized by the neural network Φ_{θ}, and a generative process (e.g., a decoder) pΨ({o_{i}i}|{R_{i}i})=ΠᵢpΨ(oᵢ|Rᵢ), parameterized by the 3D molecular density Ψ.

Both θ and Ψ may be optimized by maximizing the variational lower bound:

$$ℒ ( θ , Ψ ; {\{ {o}_{i} \}}_{i} ) = - K L ( {q}_{θ} ( {\{ {R}_{i} \}}_{i} \vert {\{ {o}_{i} \}}_{i} ) \vert {p}_{Ψ} ( {\{ {R}_{i} \}}_{i} ) ) + {𝔼}_{{q}_{θ} ( {\{ {R}_{i} \}}_{i} \vert {\{ {o}_{i} \}}_{i} )} [ log {p}_{Ψ} ( {\{ {R}_{i} \}}_{i} \vert {\{ {o}_{i} \}}_{i} ) ] , \qquad ( 9 )$$

where KL represents the Kullback-Leiber (KL) divergency, [symbol]
represents the expectation and [symbol] represents the common lines loss which, using a uniform prior p_{Ψ}({R_{i}i}) over the poses and expanding the true posterior, equals:

$$ℒ ( θ , Ψ ; {\{ {o}_{i} \}}_{i} ) = H ( {q}_{θ} ( {\{ {R}_{i} \}}_{i} \vert {\{ {o}_{i} \}}_{i} ) ) + {𝔼}_{{q}_{θ} ( {\{ {R}_{i} \}}_{i} \vert {\{ {o}_{i} \}}_{i} )} [ \frac{1}{2 {σ}^{2}} {\sum }_{i} {‖ \prod ( {R}_{i}^{- 1} Ψ ) - {o}_{i} ‖}_{2}^{2} ] , \qquad ( 10 )$$

Where a represents the standard deviation of the Gaussian noise over the images.

Rather than explicitly estimating the 3D density Ψ, by denoting with ^{H} the conjugate transpose, the 3D density Ψ may minimize the objective of Equation 10:

$${\sum }_{i} {‖ \prod ( {R}_{i}^{- 1} Ψ ) - {o}_{i} ‖}^{2} = {Ψ}^{H} ( {\sum }_{i} {R}_{i} {\prod }^{H} \prod {R}_{i}^{- 1} ) Ψ + {\sum }_{i} {‖ {o}_{i} ‖}^{2} - 2 {Ψ}^{H} ( {\sum }_{i} {R}_{i} {\prod }^{H} {o}_{i} ) , \qquad ( 11 )$$

is given by the Moore-Penrose pseudo-inverse:

$$Ψ = {( {\sum }_{i} {R}_{i} {\prod }^{H} \prod {R}_{i}^{- 1} )}^{- 1} ( {\sum }_{i} {R}_{i} {\prod }^{H} {o}_{i} ) \qquad ( 12 )$$

Given rotations that are approximately uniformly distributed, the operator ΣᵢRᵢΠ^{T}ΠRᵢ^{T} may be approximately a scalar multiple of the identity ηI, where η is the average number of images in which any 3D frequency appears.

Replacing this matrix with ηI and replacing Ψ≈72 ⁻¹(ΣᵢRᵢΠ^{H}oᵢ) in the objective function of Equation 10, produces:

$${\sum }_{i} {‖ \prod ( {R}_{i}^{- 1} Ψ ) - {o}_{i} ‖}^{2} = {η}^{- 2} {\sum }_{i j k} {o}_{j}^{H} \prod {R}_{i}^{- 1} {R}_{i} {\prod }^{H} \prod {R}_{i}^{- 1} {R}_{k} {\prod }^{H} {o}_{k} + {\sum }_{i j} {‖ {o}_{i} ‖}^{2} - 2 {η}^{- 1} {\sum }_{i j} {o}_{j}^{H} \prod {R}_{j}^{- 1} {R}_{i} {\prod }^{H} {o}_{i} . \qquad ( 13 )$$

The operator ΠRⱼRᵢ⁻¹Π^{H} may project the common line from image j to image i and, therefore, oⱼ^{H}ΠRⱼRᵢ⁻¹Π^{H}oᵢ is the inner product of the images oᵢ and oⱼ along the common line of image j and image i. The order-three quantity oⱼ^{H}ΠRⱼ⁻¹RᵢΠRᵢ⁻¹RₖΠ^{H}oᵢ is the inner product between oᵢ and oᵢₖ along the points shared between the three images i, j, k; because the intersection of three generic planes contains just the origin, which may be the average density of the molecule (e.g., the frequency 0 Fourier transform), which is a constant term.

Thus, the loss may be estimated as a simple quadratic loss expressed as:

$${\sum }_{i} {‖ \prod ( {R}_{i}^{- 1} Ψ ) - {o}_{i} ‖}^{2} \approx {\sum }_{i j} {‖ {o}_{i} ‖}^{2} - 2 {η}^{- 1} {\sum }_{i j} {o}_{j}^{H} \prod {R}_{j}^{- 1} {R}_{i} {\prod }^{H} {o}_{i} , \qquad ( 14 )$$

which enforces each pair of images (oᵢ, oⱼ) to agree along the common line defined by their respective estimated poses (Rᵢ, Rⱼ). Hence, dropping the constant terms ∥oᵢ∥², the common lines loss, which may serve as a final training objective to maximize, becomes:

$$ℒ ( θ , ; {\{ {o}_{i} \}}_{i} ) = H ( {q}_{θ} ( {\{ {R}_{i} \}}_{i} \vert {\{ {o}_{i} \}}_{i} ) ) + {𝔼}_{{q}_{θ} ( {\{ {R}_{i} \}}_{i} \vert {\{ {o}_{i} \}}_{i} )} [ \frac{1}{η {σ}^{2}} {\sum }_{i j} ℒ ( {R}_{i} {R}_{j} ) ] , \qquad ( 15 )$$

with the loss [symbol] (Rᵢ, Rⱼ)=oⱼ^{H}ΠRⱼ⁻¹RᵢΠ^{H}oᵢ, which is a function of the parameters θ of the encoder parameterizing the posteriors.

With the estimate poses Rᵢ=(xᵢ, yᵢ, zᵢ)^{T}, the vector zᵢ may define the axis orthogonal to the plane spanned by (xᵢ, yᵢ). Thus, the common line between two planes, identified by the two axes zᵢ and zⱼ, is a line orthogonal to both zᵢ and zⱼ. An orthogonal basis for this line may be obtained using the (normalized)

$$cross product {l}_{ij} = \frac{{z}_{i} \times {z}_{j}}{{‖ {z}_{i} \times {z}_{j} ‖}_{2}} .$$

The equation of the line lᵢⱼ inside both planes may be determined by expressing lᵢⱼ with respect to xᵢ, yᵢ and with respect to xⱼ, yⱼ:

xᵢ=lᵢⱼ^{T}xᵢyᵢ=lᵢⱼ^{T}yᵢxⱼ=lᵢⱼ^{T}xⱼyⱼ=lᵢⱼ^{T}yⱼ. (16)

Each of the computations of Equation 16 are differentiable with respect to the predicted poses Rᵢ,Rⱼ. Accordingly, the gradient of the neural network model may be backpropagated through the neural network model output.

The loss in Equation 15 can be implemented using:

[symbol]

(Rᵢ,Rⱼ)= [symbol] [oᵢ](λxᵢ,λyᵢ)· [symbol] ₂̅[̅o̅ⱼ̅]̅(̅λ̅x̅ⱼ̅,̅ λ̅y̅ⱼ̅)̅d λ (17)

where ·̅ represents complex conjugation and λ is an integration variable. In Equation 17, the integral compares the pair of images (oᵢ, oⱼ) at each point on the common line. The integration variable λ may be considered an index of the points on the common line.

The loss in Equation 17 may be computed using the mean squared error to achieve convergence:

[symbol]

(Rᵢ,Rⱼ)=− [symbol] [oᵢ](λxᵢ,λyᵢ)− [symbol] ₂[oⱼ](λxⱼ,λyⱼ)|²d λ (18)

The mean squared error includes the inner product in Equation 15 but also penalizes common lines that have a higher norm, which may reduce the impact of the local optima problem (e.g., where the neural network model determines the common line to be the line within an image with highest norm, regardless of its alignment with the lines in the other images). The loss in Equation 18 may be implemented by sampling a discrete number L of points along the common line in both images o i and which is differentiable with respect to the sampling coordinates {(λₗxᵢ,λₗyᵢ)}l^{L}.

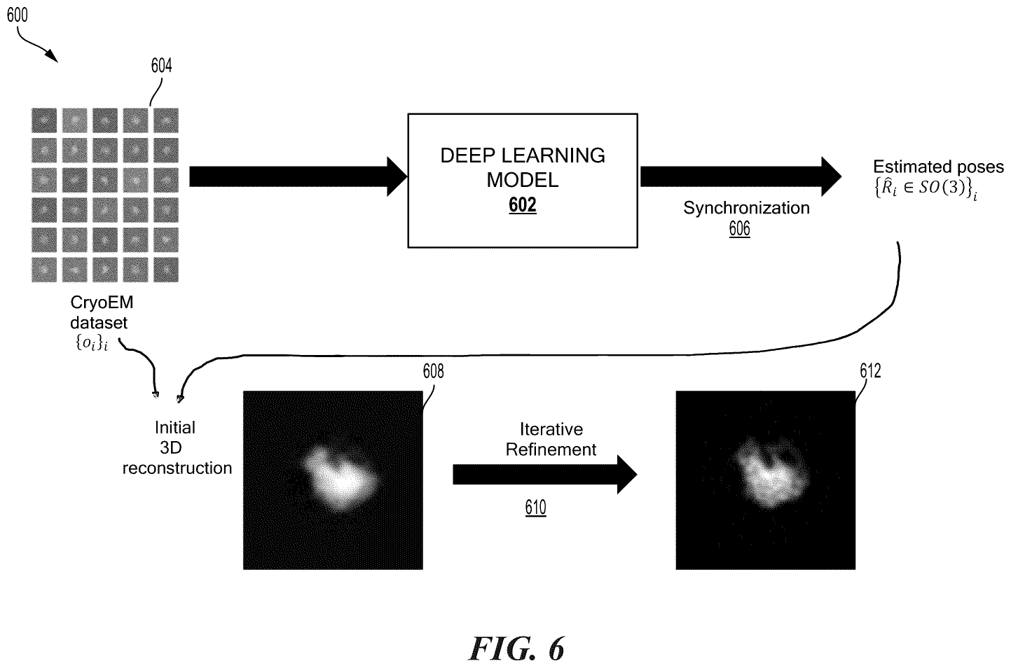

FIG. 6 is a block diagram illustrating an example processing pipeline 600 for estimating the generating of a 3D volume based on 2D images, in accordance with aspects of the present disclosure. Referring to FIG. 6, the example processing pipeline 600 may include a deep learning model 602. The deep learning model 602 may include, but is not limited to, a multilayer perceptron (MLP) or a graph neural network, for example.

The deep learning model 602, may, in some aspects be configured in an encoder-decoder arrangement (e.g., variational autoencoder). In various aspects, the deep learning model 602 may be implemented in an attention-based architecture (e.g., MLP+self-attention across nodes). In the MLP architecture, the MLP may estimate the pose of each image independently from other images, (e.g., \hat{R}ᵢ=Φ_{θ}(oᵢ)), for example. In the MLP+self-attention architecture, self-attention may be applied across the full set of images present in a mini-batch in multiple self-attention layers (e.g., four layers), for instance.

When the deep learning model 602 comprises a graph neural network, the graph neural network may implement message passing techniques to generate the estimated poses. In this case, the deep learning model 602 may estimate the pose of each image conditioned on all images in a batch.

The graph neural network may implement an approximate message passing technique to approximate a belief propagation. Eigenvectors of a graph connection Laplacian matrix may approximate a local parallel transport over the surface of a projective plane. The graph neural network may use the graph connection Laplacian to send messages between different nodes that may interpret the geometric information (local symmetries) between different features of the images. Specifically, each layer of the graph neural network may use the message passing for each channel independently and may learn a G-equivariant linear map Wₗ to mix the features of each node of the graph neural network, where l represents a layer index. In some aspects, a softmax activation may be replaced with a simpler exponential linear unit (ELU) activation applied over features in the SO(3) regular representation band-limited up to frequency (e.g., L=2). In some aspects, the graph neural network may be preceded by an O(2) equivariant MLP encoder, which processes each image independently and initializes the message passing features, for example.

Accordingly, the alignment between pairs of images and the common line loss may provide sufficient information to compute an approximate estimation of the absolute poses. As such, the deep learning model 602 may benefit from the local symmetries that may be employed to determine the alignment of image pairs as well as all images' features to estimate the pose of each single image. In some aspects, the deep learning model 602 may be an equivariant model.

The deep learning model 602 may receive a dataset 604. The dataset 604 may include 2D images, such as 2D images (e.g., 504a-e, 506a-e) of a molecule (e.g., 502) produced in a cryo-EM process as described. The deep learning model 602 may align image pairs (e.g., 504a/506a) of the 2D images based on the geometric properties of the images in the image pairs. For instance, image pair 504a and 506a may be aligned based on the planar rotation and planar reflection, which may be considered local symmetries.

The deep learning model may estimate the poses of each 2D image based on multiple 2D images (e.g., all of the 2D images or a subset of the 2D images), and a loss associated with the common line between two or more pairs of the 2D images. For instance, the image 504b may be aligned with image 506b based on the geometric properties (e.g., planar rotation and/or planar reflection) of the images 504b, 506b. Similarly, image 504c-e may be aligned with images 506c-e, respectively. The common line loss between the aligned images (e.g., 504b/506b or 504c/506c) may be determined. The common line loss for the images 504a/506a may be used with all of the 2D images (or a subset of the 2D images) to estimate a pose of the image 504a or the image 506a.

In some aspects, the common line loss for other aligned images (e.g., 504b/506b) may also be used to improve the estimated pose of each image (e.g., 506a). For example, the common line losses corresponding with all of the other aligned images (or a random subset of such common line losses) may be used to estimate of the pose of the image 504a or the image 506a. By using the common line losses corresponding with other aligned images, aspects of the present disclosure may further reduce a susceptibility of the local optima problem in estimating the poses.

Then, using the estimated poses, the global symmetry may be determined. That is, the deep learning model 602 may perform a synchronization process 606 to compute an estimated 3D pose of the molecule (e.g., 502) based on the estimated poses of each image and the aligned image pairs (e.g., 504a, 506a). For example, the full symmetry may be given by SO(3)×O(2)^{×N}, where SO(3) may act globally, while each O(2) symmetry may act locally on an estimated pose. Thus, G=SO(3)×SO(2). Accordingly, when the deep learning model 602 is implemented, for example as the graph neural network using message passing, because the features ƒ^{l}(i) of each node i include band-limited functions over SO(3), the action p^{l} of G is induced by its action over the elements of SO(3), where p^{l} is a representation used at layer l and ƒ^{l}(i) is the feature vector of node i at layer l.

Based on the estimated 3D poses, the deep learning model 602 may, in some aspects, generate an initial 3D reconstruction 608 of the molecule (e.g., 502). In some aspects, the 3D reconstruction 608 may be generated by a reconstruction model that is separate (e.g., a separate device) from the deep learning model 602. Moreover, in some aspects, the deep learning model 602 may also perform an iterative refinement process 610 to generate an improved 3D reconstruction 612.

As described, the cryo-EM problem presents a number of symmetries that may be leveraged by the deep learning model 602. If a single image oᵢ is mirrored or transformed by a planar rotation g ∈O(2), the pose of the new image g. oᵢ is related to the original image by a similar transformation (e.g., Rᵢg⁻¹). The action of the planar rotation g=r_{α}ƒ^{c}∈O(2), with α∈(0,2π) and c ∈{0,1}, on SO(3) in Rᵢg⁻¹ is given by:

$$g : {R}_{i} ↦ {R}_{i} {g}^{- 1} = {R}_{i} [ \begin{matrix}- 1 & & \\ & 1 & \\ & & - {1}^{c}\end{matrix} ] [ \begin{matrix}cos α & - sin α & \\ sin α & cos α & \\ & & 1\end{matrix} ] , \qquad ( 19 )$$

where an element g of the O(2) symmetry is composed by a planar rotation r_{α}and/or a planar reflection ƒ^{c} and c is a binary variable that indicates whether a reflection is present or not.

A local O(2) symmetry defined in Equation 19 and may be encoded into a neural network via equivariance. For example, the deep learning model 602 may be an O(2) equivariant model if the deep learning model 602 satisfies the following constraint:

Φ_{θ}(g·oᵢ, {oⱼ}_{j≠i})=Φ_{θ}(oᵢ, {oⱼ}_{j≠i}) g⁻∀g ∈O(2). (20)

In some instances, the deep learning model 602 estimates may be concentrated around the same pose (e.g., at initialization). In this case, the gradient

$$\frac{\partial ℒ ( {R}_{i} , {R}_{j} )}{\partial {z}_{i}}$$

may be particularly noisy and unstable. Accordingly, in some aspects, a regularization term may be applied to force the estimated poses to spread. For instance, a linear combination of three terms may be employed. The first term may force the center of the set of vectors {z_{i}i}(zᵢ is the viewing direction along which the volume is projected to generate oᵢ) to be close to zero λ⁽¹⁾

$$( \{ {z}_{i} \} ) = \frac{1}{3} {‖ \frac{1}{N} {\sum }_{i} {z}_{i} ‖}_{2}^{2} .$$

The second term may force the covariance of the vectors {z_{i}i} to be close to the identity matrix divided by three (e.g., the covariance of a uniform distribution on the unit sphere) λ⁽²⁾

$$( \{ {z}_{i} \} ) = \frac{1}{9} \vert Cov {λ}^{( 1 )} ( \{ {z}_{i} \} ) - \frac{1}{3} I \vert .$$

The last term λ⁽3) may represent an energy function modelling repulsive forces between each pair of vectors in {z_{i}i}, defined as λᵢⱼ⁽³⁾(zᵢ,zⱼ)=min(|zᵢ^{T}zⱼ|, 0.6). A final regularization term to minimize may be given by 0.15 λ⁽¹⁾({zᵢ})+0.3λ⁽²⁾

$$( \{ {z}_{i} \} ) = \frac{1}{{N}^{2}} {\sum }_{i \neq j} {λ}_{i j}^{( 3 )} ( {z}_{i} , {z}_{j} ) ,$$

for example.

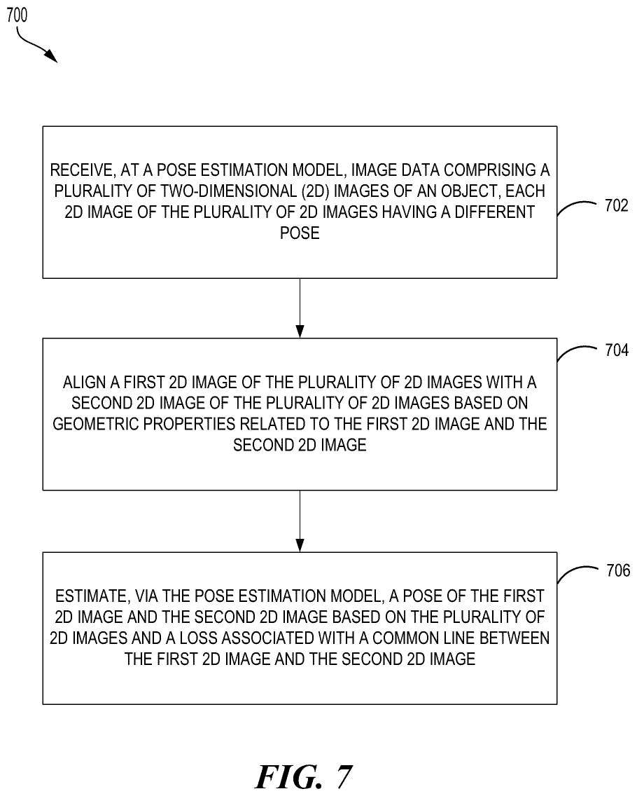

FIG. 7 is a flow diagram illustrating an example of a computer-implemented method 700 for deep pose estimation, in accordance with various aspects of the present disclosure. The computer-implemented method 700 may be performed by at least one processor such as the CPU (e.g., 102, 322), the GPU (e.g., 104, 326), and/or other processing units (e.g., DSP 324 or NPU 328), for example.

As shown in FIG. 7, at block 702 the processor receives, at a pose estimation model, image data comprising multiple two-dimensional (2D) images of an object. Each of the 2D images has a different pose. As described, for instance, with reference to FIG. 6, a deep learning model 602 may receive a dataset 604 that includes 2D images (e.g., 504a-e, 506a-e) of a molecule (e.g., 502). The deep learning model 602 may estimate the pose of each image conditioned on all images in a batch.

At block 704, the processor aligns a first 2D image of the plurality of 2D images with a second 2D image of the plurality of 2D images based on geometric properties related to the first 2D image and the second 2D image. As described, for instance, with reference to FIG. 5, the image sets may have reflection equivariance and O(2) equivariance. That is, because the two images (e.g., 504a and 506a) have an opposite viewing direction along the z-axis (e.g., z and -z, respectively), the images (e.g., 504a and 506a) may differ by a planar reflection ƒr ∈O(2). Additionally, the images (e.g., 504a and 506a) may be related by a planar rotation r ∈SO(2). Accordingly, the geometric properties among pairs of images, including (but not limited to) the planar reflection fr or the planar rotation r may be employed to align pairs of images (e.g., 504a and 506a).

At block 706, the processor estimates, via the pose estimation model, a pose of the first 2D image and the second 2D image based on the plurality of 2D images and a loss associated with a common line between the first 2D image and the second 2D image. For example, as described with reference to FIG. 6, the deep learning model 602 may estimate the pose of each image conditioned on all images in a batch. The alignment between pairs of images and the common line loss may provide sufficient information to compute an approximate estimation of the absolute poses. As such, the deep learning model 602 may benefit from the local symmetries, which may be employed to determine the alignment between image pairs, as well as all images' features to estimate the pose of each single image.

Implementation examples are described in the following numbered clauses:

1. An apparatus, comprising: at least one memory; and

at least one processor coupled to the at least one memory, the at least one processor configured to:
receive, at a pose estimation model, image data comprising a plurality of two-dimensional (2D) images of an object, each 2D image of the plurality of 2D images having a different pose; and
align a first 2D image of the plurality of 2D images with a second 2D image of the plurality of 2D images based on geometric properties related to the first 2D image and the second 2D image; and
estimate, via the pose estimation model, a pose of the first 2D image and the second 2D image based on the plurality of 2D images and a loss associated with a common line between the first 2D image and the second 2D image.

2. The apparatus of clause 1, wherein the at least one processor is further configured to transmit the 2D images and an estimated pose of each 2D image of the plurality of 2D images to a reconstruction model to estimate a three-dimensional (3D) reconstruction of the object.

3. The apparatus of clause 1 or 2, wherein the reconstruction model is included in a second apparatus that is separate from the pose estimation model.

4. The apparatus of any clauses 1 or 2, wherein the apparatus includes the pose estimation model and the reconstruction model.

5. The apparatus of any clauses 1-4, wherein the at least one processor is further configured to determine the common line between a pair of the 2D images of the plurality of the 2D images.

6. The apparatus of any clauses 1-5, wherein the pose of each 2D image is unknown to the pose estimation model prior to estimating the pose of the plurality of 2D images.

7. The apparatus of any clauses 1-6, wherein the pose of the first 2D image is estimated based on common line losses that correspond with pairs of a remaining set of the 2D images of the plurality of 2D images.

8. The apparatus of any clauses 1-7, wherein the pose of the first 2D image is estimated based on a random subset of common line losses that correspond with pairs of a remaining set of the 2D images of the plurality of 2D images.

9. The apparatus of any clauses 1-8, wherein the plurality of 2D images includes electron microscopy image data.

10. The apparatus of any clauses 1-9, wherein the object is a molecule.

11. The apparatus of any clauses 1-10, wherein the pose estimation model is an artificial neural network that is equivariant to one or more of simultaneous three-dimensional (3D) rotations of poses of the plurality of 2D images or 2D rotations and reflections of each 2D image of the plurality of 2D images, individually.

12. The apparatus of any clauses 1-11, wherein the at least one processor is further configured to estimate a three-dimensional pose of the object based on the pose of each 2D image.

13. A computer-implemented method, comprising:

receiving, at a pose estimation model, image data comprising a plurality of two-dimensional (2D) images of an object, each 2D image of the plurality of 2D images having a different pose;

aligning a first 2D image of the plurality of 2D images with a second 2D image of the plurality of 2D images based on geometric properties related to the first 2D image and the second 2D image; and

estimating, via the pose estimation model, a pose of the first 2D image and the second 2D image based on the plurality of 2D images and a loss associated with a common line between the first 2D image and the second 2D image.

14. The computer-implemented method of clause 13, further comprising transmitting the 2D images and an estimated pose of each 2D image of the plurality of 2D images to a reconstruction model to estimate a three-dimensional (3D) reconstruction of the object.

15. The computer-implemented method of clause 13 or 14, wherein the reconstruction model is included in an apparatus that is separate from the pose estimation model.

16. The computer-implemented method of clause 13 or 14, wherein the pose estimation model and the reconstruction model are included in a same apparatus.

17. The computer-implemented method of any clauses 13-16, further comprising determining the common line between a pair of the 2D images of the plurality of the 2D images.

18. The computer-implemented method of any clauses 13-17, wherein the pose of each 2D image is unknown to the pose estimation model prior to estimating the pose of the two or more 2D images.

19. The computer-implemented method of any clauses 13-18, wherein the pose of the first 2D image is based on common line losses that correspond with pairs of a remaining set of the 2D images of the plurality of 2D images.

20. The computer-implemented method of any clauses 13-19, wherein the pose of the first 2D image is estimated based on a random subset of common line losses that correspond with pairs of a remaining set of the 2D images of the plurality of 2D images.

21. The computer-implemented method of any clauses 13-20, wherein the plurality of 2D images includes electron microscopy image data.

22. The computer-implemented method of any clauses 13-21, wherein the object is a molecule.

23. The computer-implemented method of any clauses 13-22, wherein the pose estimation model is an artificial neural network that is equivariant to one or more of simultaneous three-dimensional (3D) rotations of the pose of the plurality of 2D images or 2D rotations and reflections of each 2D image of the plurality of 2D images, individually.

24. The computer-implemented method of any clauses 13-23, further comprising estimating a three-dimensional pose of the object based on an estimated pose of each 2D image.

25. A non-transitory computer-readable medium having program code recorded thereon, the program code executed by a processor and comprising:

program code to receive, at a pose estimation model, image data comprising a plurality of two-dimensional (2D) images of an object, each 2D image of the plurality of 2D images having a different pose;

program code to align a first 2D image of the plurality of 2D images with a second 2D image of the plurality of 2D images based on geometric properties related to the first 2D image and the second 2D image; and

program code to estimate, via the pose estimation model, a pose of the first 2D image and the second 2D image based on the plurality of 2D images and a loss associated with a common line between the first 2D image and the second 2D image.

The various operations of methods described above may be performed by any suitable means capable of performing the corresponding functions. The means may include various hardware and/or software component(s) and/or module(s), including, but not limited to, a circuit, an application specific integrated circuit (ASIC), or processor. Generally, where there are operations illustrated in the figures, those operations may have corresponding counterpart means-plus-function components with similar numbering.

As used, the term “determining” encompasses a wide variety of actions. For example, “determining” may include calculating, computing, processing, deriving, investigating, looking up (e.g., looking up in a table, a database, or another data structure), ascertaining and the like. Additionally, “determining” may include receiving (e.g., receiving information), accessing (e.g., accessing data in a memory) and the like. Furthermore, “determining” may include resolving, selecting, choosing, establishing, and the like.

As used, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules and circuits described in connection with the present disclosure may be implemented or performed with a general-purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, erasable programmable read-only memory (EPROM), electrically erasable programmable read-only memory (EEPROM), registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement signal processing functions. For certain aspects, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, random access memory (RAM), flash memory, read only memory (ROM), programmable read-only memory (PROM), erasable programmable read-only memory (EPROM), electrically erasable programmable Read-only memory (EEPROM), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such as the case may be with cache and/or general register files. Although the various components discussed may be described as having a specific location, such as a local component, they may also be configured in various ways, such as certain components being configured as part of a distributed computing system.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may comprise one or more neuromorphic processors for implementing the neuron models and models of neural systems described. As another alternative, the processing system may be implemented with an application specific integrated circuit (ASIC) with the processor, the bus interface, the user interface, supporting circuitry, and at least a portion of the machine-readable media integrated into a single chip, or with one or more field programmable gate arrays (FPGAs), programmable logic devices (PLDs), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module. Furthermore, it should be appreciated that aspects of the present disclosure result in improvements to the functioning of the processor, computer, machine, or other system implementing such aspects.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Additionally, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used, include compact disc (CD), laser disc, optical disc, digital versatile disc (DVD), floppy disk, and Blu-ray® disc where disks usually reproduce data magnetically, while discs reproduce data optically with lasers. Thus, in some aspects, computer-readable media may comprise non-transitory computer-readable media (e.g., tangible media). In addition, for other aspects computer-readable media may comprise transitory computer- readable media (e.g., a signal). Combinations of the above should also be included within the scope of computer-readable media.

Thus, certain aspects may comprise a computer program product for performing the operations presented. For example, such a computer program product may comprise a computer-readable medium having instructions stored (and/or encoded) thereon, the instructions being executable by one or more processors to perform the operations described. For certain aspects, the computer program product may include packaging material.

Further, it should be appreciated that modules and/or other appropriate means for performing the methods and techniques described can be downloaded and/or otherwise obtained by a user terminal and/or base station as applicable. For example, such a device can be coupled to a server to facilitate the transfer of means for performing the methods described. Alternatively, various methods described can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described to a device can be utilized.

It is to be understood that the claims are not limited to the precise configuration and components illustrated above. Various modifications, changes, and variations may be made in the arrangement, operation, and details of the methods and apparatus described above without departing from the scope of the claims.

What is claimed is:

1. An apparatus, comprising:
at least one memory; and
at least one processor coupled to the at least one memory, the at least one processor configured to:
receive, at a pose estimation model, image data comprising a plurality of two-dimensional (2D) images of an object, each 2D image of the plurality of 2D images having a different pose;
align a first 2D image of the plurality of 2D images with a second 2D image of the plurality of 2D images based on geometric properties related to the first 2D image and the second 2D image; and
estimate, via the pose estimation model, a pose of the first 2D image and the second 2D image based on the plurality of 2D images and a loss associated with a common line between the first 2D image and the second 2D image.

2. The apparatus of claim 1, wherein the at least one processor is further configured to transmit the 2D images and an estimated pose of each 2D image of the plurality of 2D images to a reconstruction model to estimate a three-dimensional (3D) reconstruction of the object.

3. The apparatus of claim 2, wherein the reconstruction model is included in a second apparatus that is separate from the pose estimation model.

4. The apparatus of claim 2, wherein the apparatus includes the pose estimation model and the reconstruction model.

5. The apparatus of claim 1, wherein the at least one processor is further configured to determine the common line between a pair of the 2D images of the plurality of the 2D images.

6. The apparatus of claim 1, wherein the pose of each 2D image is unknown to the pose estimation model prior to estimating the pose of the plurality of 2D images.

7. The apparatus of claim 1, wherein the pose of the first 2D image is estimated based on common line losses that correspond with pairs of a remaining set of the 2D images of the plurality of 2D images.

8. The apparatus of claim 1, wherein the pose of the first 2D image is estimated based on a random subset of common line losses that correspond with pairs of a remaining set of the 2D images of the plurality of 2D images.

9. The apparatus of claim 1, wherein the plurality of 2D images includes electron microscopy image data.

10. The apparatus of claim 1, wherein the object is a molecule.

11. The apparatus of claim 1, wherein the pose estimation model is an artificial neural network that is equivariant to one or more of simultaneous three-dimensional (3D) rotations of poses of the plurality of 2D images or 2D rotations and reflections of each 2D image of the plurality of 2D images, individually.

12. The apparatus of claim 1, wherein the at least one processor is further configured to estimate a three-dimensional pose of the object based on the pose of each 2D image.

13. A computer-implemented method, comprising:
receiving, at a pose estimation model, image data comprising a plurality of two-dimensional (2D) images of an object, each 2D image of the plurality of 2D images having a different pose;
aligning a first 2D image of the plurality of 2D images with a second 2D image of the plurality of 2D images based on geometric properties related to the first 2D image and the second 2D image; and
estimating, via the pose estimation model, a pose of the first 2D image and the second 2D image based on the plurality of 2D images and a loss associated with a common line between the first 2D image and the second 2D image.

14. The computer-implemented method of claim 13, further comprising transmitting the 2D images and an estimated pose of each 2D image of the plurality of 2D images to a reconstruction model to estimate a three-dimensional (3D) reconstruction of the object.

15. The computer-implemented method of claim 14, wherein the reconstruction model is included in an apparatus that is separate from the pose estimation model.

16. The computer-implemented method of claim 14, wherein the pose estimation model and the reconstruction model are included in a same apparatus.

17. The computer-implemented method of claim 13, further comprising determining the common line between a pair of the 2D images of the plurality of the 2D images.

18. The computer-implemented method of claim 13, wherein the pose of each 2D image is unknown to the pose estimation model prior to estimating the pose of the two or more 2D images.

19. The computer-implemented method of claim 13, wherein the pose of the first 2D image is based on common line losses that correspond with pairs of a remaining set of the 2D images of the plurality of 2D images.

20. The computer-implemented method of claim 13, wherein the pose of the first 2D image is estimated based on a random subset of common line losses that correspond with pairs of a remaining set of the 2D images of the plurality of 2D images.

21. The computer-implemented method of claim 13, wherein the plurality of 2D images includes electron microscopy image data.

22. The computer-implemented method of claim 13, wherein the object is a molecule.

23. The computer-implemented method of claim 13, wherein the pose estimation model is an artificial neural network that is equivariant to one or more of simultaneous three-dimensional (3D) rotations of the pose of the plurality of 2D images or 2D rotations and reflections of each 2D image of the plurality of 2D images, individually.

24. The computer-implemented method of claim 13, further comprising estimating a three-dimensional pose of the object based on an estimated pose of each 2D image.

25. A non-transitory computer-readable medium having program code recorded thereon, the program code executed by a processor and comprising:
program code to receive, at a pose estimation model, image data comprising a plurality of two-dimensional (2D) images of an object, each 2D image of the plurality of 2D images having a different pose;
program code to align a first 2D image of the plurality of 2D images with a second 2D image of the plurality of 2D images based on geometric properties related to the first 2D image and the second 2D image; and
program code to estimate, via the pose estimation model, a pose of the first 2D image and the second 2D image based on the plurality of 2D images and a loss associated with a common line between the first 2D image and the second 2D image.
